(19) United States
(12) Patent Application Publication
(10) Pub. No.: US 2020/0279327 A1
(43) Pub. Date: Sep. 3, 2020

(54) RISK REVERSAL INDEX

(71) Applicant: WELLS FARGO BANK, N.A., SAN FRANCISCO, CA (US)

(72) Inventors: Philip S. Douthit, Greenwich, CT (US); Benjamin R. Adams, Darien, CT (US); Richard Silva, Fairfield, CT (US); William Threadgill, Harrison, NY (US); Jared Knote, Brooklyn, NY (US)

(73) Assignee: WELLS FARGO BANK, N.A., SAN FRANCISCO, CA (US)

(21) Appl. No.: 14/285,950

(22) Filed: May 23, 2014

Related U.S. Application Data
(60) Provisional application No. 61/827,101, filed on May 24, 2013.

(51) Int. Cl. G06Q 40/04

(52) U.S. Cl. CPC G06Q 40/04

(57) ABSTRACT

A computer-implemented method and a computer system for a risk reversal index comprises a computer processor that is configured to sell at least one out-of-the-money put option on an underlying index, calculate a premium from the sale of the out-of-the- money put option, use the premium to buy at least one out-of-the-money call option on the underlying index, and invest any remaining premium after purchase of the out-of-the-money call option in a cash-equivalent position having a value. The out-of-the-money put option is sold and the out-of-the-money call option is bought on a roll date.

### CROSS-REFERENCE TO RELATED APPLICATIONS

This application claims priority from U.S. patent application Ser. No. 61/287,101, filed on May 24, 2013. The disclosure of which is incorporated herein by reference in its entirety.

### FIELD OF THE INVENTION

The present invention relates to a system for derivatives securities, more particularly to a risk reversal index.

### BACKGROUND OF THE INVENTION

In securities markets, an option is the right to buy or sell stock at a specified price within a specified time period. The value of the option is derived from the underlying security for which the option is a right to buy or sell. Options are often referred to as derivative securities. Options take various forms including calls and puts. A call option on stock is a contract that entitles the buyer to purchase stock at a specified price (i.e., strike price) within a specified time period. A put option on stock is a contract that entitles the buyer to sell stock at a specified price (i.e., strike price) within a specified time period. Investors in options do not receive the benefit of owning the underlying stock. Investors purchase options because they expect the price of the option to rise above (in the case of a call option) or fall below (in the case of a put option) the applicable strike price. If price of the stock is greater (in the case of a call option) or less (in the case of a put option) than the per-share strike price, the option is referred to as being “in-the-money.” If the price of the stock is less (in the case of a call option) or greater (in the case of a put option) than the strike price, the option is referred to as being “out-of-the-money.” If the price of the stock equals the strike price, the option is referred to as being “at-the-money.” Since options offer leveraged exposure, they are potentially risky investments. A purchaser of an option could easily lose the entire amount invested in the option.

There are existing option strategies to manage risk associated with individual stocks. For example, there is an option strategy known as a risk reversal strategy, typically employed for a single stock, in which the strategy is to sell an out-of-the-money put option and buy an out-of-the-money call option.

With the creation of options exchanges such as the Chicago Board Options Exchange (CBOE), a liquid secondary market was created for the purchase and sale of options. Call and put options provide an investor with an opportunity to take long and short positions and to construct hedge positions to reduce risk. In addition to stock options, other types of options are traded on exchanges such as the stock index option which is not based upon the stock of an individual company but rather on an index comprised of stocks

An index is a statistical indicator providing a representation of the value of the securities which constitute it. Indices often serve as indicators for a given market or industry and benchmark against which financial or economic performance is measured. Examples of widely-accepted indices in the United States include Dow Jones Industrial Average Index (the “Dow 30”), National Association of Securities Dealers Automated Quotations Index (the “NASDAQ 100”) and the S&P 500 Index (the “SPX”), among others. At present, the motivation or focus of such indices is to track a particular market or segment or sector of a market. None of the existing indices have a focus of reducing volatility in the market.

### SUMMARY OF THE INVENTION

The present invention relates to a computer-implemented method and a computer system for a risk reversal index. The computer system generally comprises a computer processor that is configured to sell at least one out-of-the-money put option on an underlying index, calculate a premium from the sale of the out-of-the-money put option, use the premium to buy at least one out-of-the-money call option on the underlying index, and invest any remaining premium after purchase of the out-of-the-money call option in a cash-equivalent position having a value. The out-of-the-money put option is sold and the out-of-the-money call option is bought on the same day which day is referred to herein as a roll date.

In another aspect of the invention, a computer-readable medium comprises processor executable program instructions for the risk reversal index. The instructions may be configured for causing the processor to execute the steps of selling at least one out-of-the-money put option on an underlying index, calculating a premium from the sale of the out-of-the-money put option, using the premium to buy at least one out-of-the-money call option on the underlying index, and investing any remaining premium after purchase of the out-of-the-money call option in a cash-equivalent position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a block diagram of a computer system for implementing a risk reversal index.

### DETAILED DESCRIPTION OF THE INVENTION

The following detailed description of the embodiment(s) is merely exemplary in nature and is in no way intended to limit the invention, its application, or uses.

The present invention is directed to a computer system and method for implementing a risk reversal index (also referred to herein as an “RXM” index). The risk reversal index tracks the value of a passive investment strategy comprised of combining or overlaying a short position in exchange-traded put options and a long position in exchange-traded call options with a cash-equivalent position. In a preferred aspect of the present invention, the exchange-traded put options consist of Chicago Board Options Exchange (CBOE)-traded S&P 500 put options and the exchange-traded call options comprise CBOE-traded S&P 500 call options. The S&P 500 Index is referred to herein as the “SPX”. In a preferred aspect of the present invention, the cash-equivalent position is represented by U.S. Treasury Bills. The U.S. Treasury Bills are also referred to herein as the “Treasury portfolio.”

The index of the present invention is structured to achieve equity-like returns over a number of investment cycles with lower volatility in order to provide better risk adjusted returns. The computer implemented method provides a systematic approach to managing volatility yet providing equity-like returns. The method of the present invention achieves lower volatility, for example, by combining options and extending the strike prices “out-of-the-money,” as opposed to other indices which employ a single option with a strike price “at-the-money.” The method of the present invention is able to achieve lower volatility and equity-like returns while still creating synthetic exposure to the S&P 500. The risk reversal index of the present invention is also fully collateralized. Furthermore, the risk reversal index of the present invention is unlike other indices in which the potential returns (i.e. the upside) are capped.

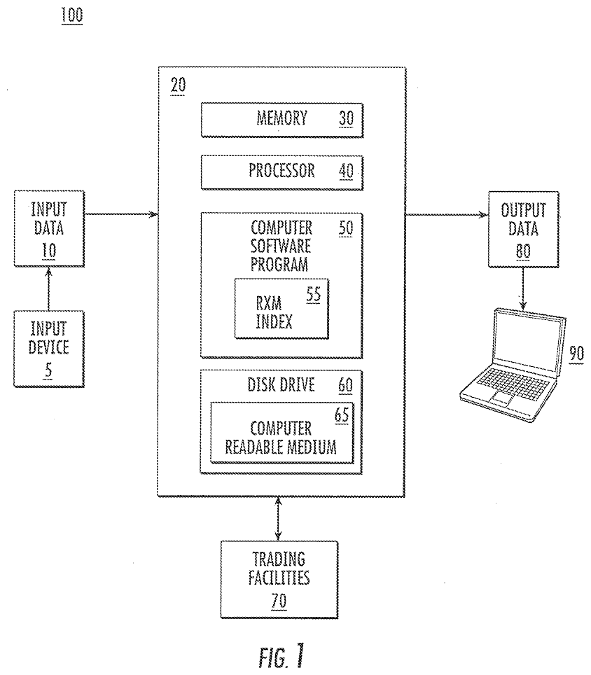

Referring to the figures, FIG. 1 is a block diagram of a computer system for implementing a risk reversal index in accordance with aspects of the present invention. As illustrated in FIG. 1, the computer system 100 generally comprises a computer 20 having memory 30, a processor 40, a computer software program(s) 50, an input device 5, input data 10, output device 90, output data 80, a disk drive or other mass storage device 60, among other components. Disk drive or other mass storage device 60 may include a computer-readable medium 65 in which one or more sets of instructions, e.g. software, can be embedded. Further, the instructions may embody one or more of the methods or logic as described herein. The output device 90 is in communication with the computer 20 for providing output data 80. The computer 20 is in communication with one or more trading facilities 70.

In an aspect of the invention, instructions may reside within the memory 30 and/or within the processor 40 during execution by the computer 30. The memory 30 comprises instructions executable by the processor 40. The memory 30 and the processor 40 also may include a computer-readable medium. While the computer-readable medium may be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

The memory 30, processor 40, and computer software program(s) 50 are used to process and compute the input data 10 in the computer system 100 to generate output data 80. The output data 80 is transmitted to a computer output device 90 such as a computer display terminal or a printer.

In accordance with various aspects of the present invention, the methods described herein may be implemented by a software program(s) 50 executable by computer system 100. The above discussed software program 50 may comprise one or more software modules that perform certain tasks. The software modules comprise automated decision rules and computer-implemented algorithms which are used to, for example, estimate, calculate and generate specific trade parameters. As shown in FIG. 1, the computer system comprises a RXM Index module 55. The RXM Index module 55 is used to perform various steps in the computer-implemented method of the present invention.

The present invention has been described in the context of a fully functional computer system, however, those skilled in the art will appreciate that the present invention is capable of being distributed as a program product or implemented in a variety of forms. The computer system can be implemented using electronic devices that provide voice, video or data communication. Further, while a single computer system is illustrated in FIG. 1, the term “system” shall also be taken to include any collection of systems or sub-systems that individually or jointly execute a set, or multiple sets, of instructions to perform one or more computer functions.

The computer system may operate as a standalone device or may be connected to other computer systems or devices such as via a computer network.

In accordance with the present invention, the method of the risk reversal index comprises selling out-of-the-money puts and buying out-of-the-money calls on the same day which day is referred to herein as a “roll date.” The roll date provides a systematic approach to the risk reversal index. It is contemplated and within the scope of the present invention that the roll date is before, at or after expiration of the option. However, in a preferred aspect of the present invention, the roll date is prior to expiration of the option. On the roll date, the put options are closed out (i.e., purchased, so no longer short), the call options are closed out (i.e. sold, so no longer long) and then new option positions are established. It is contemplated and within the scope of the present invention that the new options have a remaining term as of the roll date of one to 12 months, preferably one-month to six-months. In a preferred aspect of the present invention, the new options have a remaining term as of the roll date of one month.

As indicated above in accordance with the method of the present invention, the options (such as one month options, two month options, etc.) purchased are held until the roll date at which point they are sold (in the case of the call options) or purchased (in the case of the put options). Losses from the expiring puts are debited from the underlying cash-equivalent position. Gains from the sale of the expiring call position are added to the cash-equivalent position. New puts are sold, with premiums collected to finance the purchase of call options. It is contemplated and with in the scope of the present invention that the new call options purchased may be determined either as an equal number of call options purchased as the number of put options sold or as an equal dollar amount as the put options sold. In a preferred aspect of the present invention, the number of new call options purchased equals the number of put options sold (subject to the feature described in paragraph [0030]. Any premium collected in excess of that used to buy the calls is added to the cash-equivalent position. Various methods may be used to determine the roll date and to determine the percentage out-of-the-money (in the case of put options) or in-the-money (in the case of call options) the options are struck relative to the spot level of the index underlying the exchange-traded options, referred to herein as the “underlying index.” For example, one month SPX put options may be sold at 95% of the spot level of the SPX, for example, on the Tuesday before the third Friday of the month. The one month SPX call options may be purchased at 105% of the spot level of the SPX, also on the Tuesday before the third Friday of the month. In this example, the roll date occurs before the option expiration date, in this case three days before the option expiration date, which is the third Friday of the month.

In accordance with the computer implemented method of the present invention, the number of SPX puts sold is calculated. The number of SPX puts sold is determined by the value of the cash-equivalent position to ensure full collateralization. The value of the cash-equivalent position must be equal to the maximum possible loss from final settlement of the put option.

The value of the Treasury portfolio is as set forth in Equation (1):

M=N^{p}*K^{p} Equation (1)

where

M=the value of the Treasury portfolio

N^{p}=the number of puts sold

K^{p}=the strike price of the put options sold

In accordance with the computer implemented method of the present invention, the number of SPX calls purchased is calculated in the manner described above in paragraph [0022]. As previously described, in a preferred aspect of the present invention, the number of calls purchased is determined by the number of puts sold. Premiums collected from the sold puts in excess of that required to purchase calls are included in the cash-equivalent position. If the premiums collected from the puts is less than that needed to purchase the calls, then no new options positions are entered into on that roll date once the existing options positions are closed. The same market conditions are evaluated on the subsequent roll date to determine whether to enter new option positions on that roll date. In other aspects of the present invention, where the number of call options purchased is an equal dollar amount as the put options sold, no such restriction would be employed.

In accordance with the computer implemented method of the present invention, the strike prices are selected. Generally, the put options are sold at a percentage (less than 100%) of the spot level of the underlying index and the call options are purchased at a percentage (greater than 100%) of the spot level of the underlying index.

In a preferred aspect of the present invention, the put options are sold at 95% of the at-the-money put option relative to the spot level of the SPX, and the call options are purchased at 105% of the at-the-money call option relative to the spot level of the SPX at a fixed, specified time, referred to as the “Roll Time.” In a preferred aspect of the present invention, the Roll Time is 11:00 a.m. ET. For example, if the last spot level of the SPX reported at 11:00 a.m. ET is 1233.10 and the closest listed SPX put strike price below 1233.10 is 1230 , then 1230 strike SPX puts are considered “at-the-money.” The put option selected would be the one that is 5% below such at-the-money put option. The same method is employed to determine the at-the-money call option and the 5% out-of-the-money call option.

In a preferred aspect of the present invention, the put option sold is the option closest to, but not greater than, 95% of the at-the-money put option when the at-the-money level is calculated. In a preferred aspect of the present invention, the call option purchased is the closest to, but not greater than, 105% of the at-the-money put option when the at-the-money level is calculated.

In accordance with the computer-implemented method of the present invention, the sales prices of the puts sold and calls purchased are determined.

In a preferred aspect of the present invention, the SPX puts options are deemed to be sold at a price equal to the volume-weighted average of the traded prices (“VWAP”) of put options with the pre-determined strike during the half-hour period beginning one half hour after the Roll Time (the “Put VWAP Period”). The VWAP is calculated in a two-step process: first, trades executed during the Put VWAP Period that are identified as having been executed as part of a “spread” are excluded, and then the weighted average of all remaining transaction prices at that strike during the Put VWAP Period is calculated, with weights equal to the fraction of total non-spread volume transacted at each price during this period. If no transactions occur at the new put strike during the Put VWAP Period, then the new put options are deemed sold at the last bid price reported at the ending time of the Put VWAP Period.

In a preferred aspect of the present invention, the SPX call options are deemed to be sold at a price equal to the VWAP of call options with the pre-determined strike during the half-hour period beginning one hour after the Roll Time (the “Call VWAP Period”). The VWAP is calculated in a two-step process: first, trades executed during the Call VWAP Period that are identified as having been executed as part of a “spread” are excluded, and then the weighted average of all remaining transaction prices at that strike during the Call VWAP Period is calculated, with weights equal to the fraction of total non-spread volume transacted at each price during this period. If no transactions occur at the new put strike during the Call VWAP Period, then the new put options are deemed sold at the last bid price reported at the ending time of the Call VWAP Period.

### Risk Reversal Index Calculation

In accordance with the present invention, the Risk Reversal (RXM) Index level is calculated at the close of option trading daily. The RXM represents the mark-to-market value of the base date $100 invested in the RXM strategy. The level of the RXM equals the value of the cash-equivalent position, represented in a preferred aspect of the present invention by U.S. Treasury Bills, less the mark-to-market value of the puts plus the mark-to-market value of the calls:

As shown in Equation (2):

Mₜ=Mₜ is the total Treasury Bill balance at the close of date t

N^{p}ₗₐₛₜ=the number of put options sold at the last Roll Date

P^{p}ₜ=the arithmetic average of the last bid and ask prices of the put option reported before 4:00 p.m. ET on date t

N^{c}ₗₐₛₜ=the number of call options purchased at the last Roll Date

P^{c}ₜ=the arithmetic average of the last bid and ask prices of the call option reported before 4:00 p.m. ET on date t

Where

RXMₜ=Mₜ−N^{p}ₗₐₛₜ*P^{p}ₜ+N^{c}ₗₐₛₜ*P^{c}ₜ Equation (2)

On non-roll dates, the Treasury Bills are calculated by compounding the previous day's Treasury Bills value by the daily three-month rate.

As set forth below:

rₜ₋₁=the Treasury Bill rate from the previous to the current close

where

Mₜ=(1+rₜ₋₁)Mₜ₋₁ Equation (3)

In instance where the Roll Date is before the option expiration date, the method of the present invention comprises the following. On Roll Dates, the Treasury Bills will be sold and a new position in the Treasury Bills (such as on-the-run Treasury Bills) is established. In a preferred aspect of the present invention, the term of the on-the-run Treasury Bills is the nearest Treasury Bill maturity immediately following the next following roll Date. Funds are debited or credited from the Treasury Bill portfolio based on the difference between the VWAP of the expiring options being sold at the roll is less than the VWAP at which those options were purchased. New puts are sold and calls purchased. The new Treasury Bill position is as follows:

Mₜ=the total U.S. Treasury Bill balance at the close of date t

Mₜ₋₁=the total U.S. Treasury Bill balance at the close of date t−1

rₜ₋₁=the Treasury Bill rate from the previous to the current close

N^{p}ₗₐₛₜ=the number of puts being rolled out of

N^{c}ₗₐₛₜ=the number of calls being rolled out of

P^{p-old}_{vwap-0}=volume-weighted average price (VWAP) at which the expiring puts are closed out

P^{p-old}_{vwap-1}=volume-weighted average price (VWAP) at which the expiring puts were sold

P^{c-old}_{vwap-0}=volume-weighted average price at which the expiring calls are closed out

P^{c-old}_{vwap-1}=volume-weighted average price at which the expiring calls are purchased

N^{p}_{new}=the number of new puts being sold

N^{c}_{new}=the number of new calls being purchased

P^{p-new}_{vwap}=volume-weighted average price at which the new puts are sold

P^{c-new}_{vwap}=volume-weighted average price at which the new calls are purchased

Mₜ=Σ(1+r ₜ₋₁)Mₜ₋₁−N^{p}ₗₐₛₜ*(P^{p-old}_{vwap-1}−P^{p}−old_{vwap-0})+N^{c}ₗₐₛₜ*(P^{c-old}_{vwap-1}−P^{c-old}_{vwap-0})+N^{p}_{new}*P^{p-new}_{vwap}−N^{c}_{new}*P^{c-new}_{vwap-}N^{c}_{new}*P^{c-new}_{vwap} Eqn (4)

In instance where the roll date is the option expiration date, on roll dates, the Treasury Bills will be sold and a new position in the Treasury Bills (such as on-the-run three-month) is established. If puts are in-the-money, such amount is debited from the Treasury portfolio. New puts are sold. Cash is collected for final settlement if the calls are in-the-money, and new calls are purchased. The new Treasury position is as follows:

Mₜ=the total U.S. Treasury Bill balance at the close of date t

Mₜ−1=the total U.S. Treasury Bill balance at the close of date t−1

rₜ−1=the Treasury Bill rate from the previous to the current close

N^{p}ₗₐₛₜ=the number of puts being rolled out of

N^{c}ₗₐₛₜ=the number of calls being rolled out of

K^{p}_{old}=the strike price of the puts being rolled out of

K^{c}_{old}=the strike price of the calls being rolled out of

P^{p}ₜ=price at date, t, for the puts

P^{c}ₜ=price at date, t, for the calls

P^{p}_{vwap}=volume-weighted average price at which the new options are sold

Mₜ=Σ(1+rₜ₋₁)Mₜ₋₁−N^{p}ₗₐₛₜ*Max[0, K^{p}_{old-}P^{p}ₜ]+N^{c}ₗₐₛₜ*Max[0, P^{c}ₜ₋K^{c}_{old}]+N^{p}_{new}*P^{p}_{vwap}−N^{C}_{new}*P^{c}ₜ Eqn (5):

The Risk Reversal Index (RXM) is designed to represent a proposed hypothetical risk reversal strategy. Like many passive indexes, the RXM Index does not take into account significant factors such as transaction costs and taxes and, because of factors such as these, many or most investors should be expected to underperform passive indexes.

As will be appreciated by those of ordinary skill in the art, mechanisms for creating an index, derivative investment instruments based thereon and other features described above may all be modified for application to other derivative investment instruments, such as futures and options, within the purview and scope of the present disclosure.

One or more aspects of the disclosure may be referred to herein, individually and/or collectively, by the term “invention” merely for convenience and without intending to voluntarily limit the scope of this application to any particular invention or inventive concept.

Furthermore, it will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A computer system for a risk reversal index, the computer system comprising:
a processor configured to execute instructions for an investment strategy comprising:
receiving input data from at least one trading facility at a specified time;
processing the input data, wherein the input data includes a spot level of an underlying index;
estimating, calculating, and generating trade parameters based on the processed input data, wherein the trade parameters include a roll date and an at-the-money level based on the spot level of the underlying index;
selling at least one out-of-the-money put option on the underlying index at the roll date based, at least in part, on the trade parameters,
calculating a premium from the sale of the out-of-the-money put option,
using the premium to buy at least one out-of-the-money call option on the underlying index, and
investing any remaining premium after purchase of the out-of-the-money call option in a cash-equivalent position having a value equal to a maximum possible loss from final settlement of the sale of the put option, wherein the value of the cash-equivalent position is a value of a U.S. Treasury portfolio set forth in Equation (1):
M=N^{P}*K^{P} Equation (1)
where
M=the value of the U.S. Treasury portfolio
N^{p}=the number of puts sold
K^{p}=the strike price of the put options sold; and
wherein the instructions include instructions to sell the out-of-the-money put option that is the option closest to but not greater than 95% of the at-the-money put option when the at-the-money level is calculated and to buy the out-of-the-money call option on the roll date, and
wherein the risk reversal index tracks an overall value of the investment strategy.

2. (canceled)

3. The computer system according to claim 1, wherein the roll date is before, at or after expiration of the put option or the call option.

4. The computer system according to claim 1, wherein the roll date is a specified date.

5. The computer system according to claim 1, wherein the put option has a remaining term as of the roll date of 1 to 12 months.

6. The computer system according to claim 1, wherein the call option has a remaining term as of the roll date of 1 to 12 months.

7. The computer system according to claim 1, wherein a loss from an expiring put option is debited from the cash-equivalent position.

8. The computer system according to claim 1, wherein the out-of-the-money call option is purchased in a number equal to out-of-the-money put options sold.

9. The computer system according to claim 1, wherein the out-of-the-money call option is purchased in an equal monetary amount as out-of-the-money put options sold.

10. (canceled)

11. The computer system according to claim 1, wherein the instructions further comprise to purchase the call option that is the option closest to but not greater than 105% of the at-the-money put option when the at-the-money level is calculated.

12. The computer system according to claim 1, wherein the instructions further comprise to calculate a number of out-of-the money put options sold.

13. The computer system according to claim 12, wherein the number of out-of-the-money put options sold is determined by the value of the cash-equivalent position.

14. (canceled)

15. (canceled)

16. The computer system according to claim 1, wherein the underlying index is the S&P 500 Index.

17. (canceled)

18. A method for a risk reversal index in a computer system having a processor, the method comprising:
executing by the processor instructions to:
receive input data from at least one trading facility at a specified time,
process the input data, wherein the input data includes a spot level of an underlying index,
estimate, calculate, and generate trade parameters based on the processed input data,
wherein the trade parameters include a roll date and an at-the-money level based on the spot level of the underlying index,
sell an out-of-the-money put option on the underlying index based, at least in part, on the trade parameters, wherein the out-of-the-money option is the option that is closest to but not greater than 95% of the at-the-money put option when the at-the-money level is calculated,
calculate a premium from the sale of the out-of-the-money put option,
use the premium to buy an out-of-the-money call option on the underlying index, and
invest any remaining premium after purchase of the out-of-the-money call option in a cash-equivalent position having a value, and
calculate a risk reversal index level, wherein the risk reversal index level equals a value of the cash-equivalent position represented by U.S. Treasury Bills, less a mark-to-market value of the put options plus the mark-to-market value of the call options as set forth in Equation (2):
RXMₜ=Mₜ−N^{p}ₗₐₛₜ*P^{p}ₜ+N^{c}ₗₐₛₜ*P^{c}ₜ Equation (2)
where
Mₜ=the total U.S. Treasury Bill balance at the close of date t,
N^{P}ₗₐₛₜ=the number of put options sold at the last roll date,
P^{P}ₜ=the arithmetic average of the last bid and ask prices of the put option reported before 4:00 p.m. ET on date t,
N^{C}ₗₐₛₜ=the number of call options purchased at the last roll date, and
P^{C}ₜ=the arithmetic average of the last bid and ask prices of the call option reported before 4:00 p.m. ET on date t.

19. The method according to claim 18, wherein the instructions to the processor further comprise to select a strike price.

20. (canceled)

21. The method according to claim 18, wherein the instructions to the processor further comprise to purchase the call option at a percentage of greater than 100% of the spot level of the underlying index.

22. The method according to claim 18, wherein the underlying index is the S&P 500 Index.

23. The method according to claim 22, wherein the instructions to the processor further comprise to sell the put option at 95% of the spot level of the S&P 500 Index.

24. The method according to claim 22, wherein the instructions to the processor further comprise to purchase the call option at 105% of the spot level of the S&P 500 Index.

25. (canceled)

26. The method according to claim 18, wherein the instructions to the processor further comprise to purchase the call option that is the option closest to but not greater than 105% of the at-the-money put option when the at-the-money level is calculated.

27. The method according to claim 18, wherein the instructions to the processor further comprise to determine a sales price of put options sold.

28. The method according to claim 18, wherein the instructions to the processor further comprise to determine a sales price of call options purchased.

29. The method according to claim 18, wherein the put option is a S&P 500 Index put option.

30. The method according to claim 18, wherein the call option is a S&P 500 Index call option.

31. The method according to claim 29, wherein the S&P 500 Index put option is deemed to be sold at a price equal to the volume-weighted average of traded prices (VWAP) of put options with the pre-determined strike during a Put VWAP Period.

32. The method according to claim 30, wherein the S&P 500 Index call option is deemed to be sold at a price equal to the volume-weighted average of traded prices (VWAP) of call options with a pre-determined strike during a Call VWAP Period.

33. (canceled)

34. The method according to claim 18, wherein the risk reversal index level is calculated at close of option trading daily.

35. (canceled)

36. The method according to claim 18, wherein on a non-roll date, the U.S. Treasury Bills are calculated by compounding the U.S. Treasury Bills value of the previous day by daily three-month rate as set forth in Equation (3):
Equation (3)
where
Mₜ=the total U.S. Treasury Bill balance at the close of date t
rₜ₋₁=the Treasury Bill rate from the previous to the current close, and
Mₜ₋₁=the total U.S. Treasury Bill balance at the close of date t−1.

37. The method according to claim 18, wherein on a roll date U.S. Treasury Bills are sold and a new position in the U.S. Treasury Bills is established.

38. The method according to claim 18, wherein the term of on-the-run U.S. Treasury Bills is the nearest U.S. Treasury Bill maturity immediately following the next following roll date.

39. The method according to claim 37, wherein the new Treasury Bill position is calculated as set forth in Equation (4):
Mₜ=Σ(1+r ₜ₋₁)Mₜ₋₁−N^{p}ₗₐₛₜ*(P^{p-old}_{vwap-1}−P^{p}−old_{vwap-0})+N^{c}ₗₐₛₜ*(P^{c-old}_{vwap-1}−P^{c-old}_{vwap-0})+N^{p}_{new}*P^{p-new}_{vwap}−N^{c}_{new}*P^{c-new}_{vwap-}N^{c}_{new}*P^{c-new}_{vwap}
where
Mₜ=the total U.S. Treasury Bill balance at the close of date t,
Mₜ₋₁=the total U.S. Treasury Bill balance at the close of date t−1,
rₜ₋₁=the U.S. Treasury Bill rate from the previous current close
N^{P}ₗₐₛₜ=the number of puts being rolled out of,
N^{c}ₗₐₛₜ=the number of calls being rolled out of,
P^{p-old}_{vwap-0}=volume-weighted average price (VWAP) at which the expiring puts are closed out,
P^{p-old}_{vwap-1}=volume-weighted average price (VWAP) at which the expiring puts were sold,
P^{c-old}_{vwap-0}=volume-weighted average price at which the expiring calls are closed out,
P^{c-old}_{vwap-1}=volume-weighted average price at which the expiring calls are purchased,
N^{P}_{new}=the number of new puts being sold,
N^{e}_{new}=the number of new calls being purchased,
P^{P-new}_{vwap}=volume-weighted average price at which the new puts are being sold, and
P^{c-new}_{vwap}=volume-weighted average price at which the new calls are purchased.

40. The method according to claim 37, wherein in an instance where the roll date is the option expiration date, on roll dates, the U.S. Treasury Bills are sold and a new position in the Treasury Bills is established.

41. The method according to claim 40, wherein the new position in the Treasury Bills is calculated as set forth in Equation (5):
Mₜ=Σ(1+rₜ₋₁)Mₜ₋₁−N^{p}ₗₐₛₜ*Max[0, K^{p}_{old-}P^{p}ₜ]+N^{c}ₗₐₛₜ*Max[0, P^{c}ₜ₋K^{c}_{old}]+N^{p}_{new}*P^{p}_{vwap}−N^{C}_{new}*P^{c}ₜ
where
Mₜ=the total Treasury Bill balance at the close of date t,
Mt−1=the total U.S. Treasury Bill balance at the close of date t−1,
rt−1=the Treasury Bill rate from the previous to the current close,
N^{P}ₗₐₛₜ=the number of puts being rolled out of,
N^{c}ₗₐₛₜ=the number of calls being rolled out of,
K^{p}_{old}=the strike price of the puts being rolled out of,
K^{c}_{old}=the strike price of the calls being rolled out of,
P^{p}ₜ=price at date, t, for the puts
P^{c}ₜ=price at date, t, for the calls, and
P^{p}_{vwap}=volume-weighted average price at which the new options are sold.

42. A non-transitory computer readable media with computer executable instructions for a risk reversal index, the instructions configured for causing the processor to execute the steps of:
receive input data from at least one trading facility at a specified time,
process the input data, wherein the input data includes a spot level of an underlying index,
estimate, calculate, and generate trade parameters based on the processed input data, wherein the trade parameters include a roll date and an at-the-money level based on the spot level of the underlying index,
sell at least one out-of-the-money put option on the underlying index based, at least in part, on the trade parameters, wherein the at least one out-of-the money put option is the option closest to but not greater than 95% of the at-the-money put option when the at-the-money level is calculated,
calculate a premium from the sale of the out-of-the-money put option,
use the premium to buy at least one out-of-the-money call option on the underlying index, and
invest the remaining premium after purchase of the out-of-the-money call option in a cash-equivalent position having a value equal to a maximum possible loss from a final settlement of the sale of the put option, wherein the value of the cash-equivalent position is a value of a U.S. Treasury portfolio set forth in Equation (1):
M=N^{P}*K^{P} Equation (1)
where
M=the value of the U.S. Treasury portfolio
N^{P}=the number of puts sold, and
K^{P}=the strike price of the put options sold.
